(19) United States
(12) Patent Application Publication
(10) Pub. No.: US 2025/0117538 A1
(43) Pub. Date: Apr. 10, 2025

(54) OPTIMAL DESIGN METHOD FOR TOP CROSS BEAMS OF ROPS FRAMEWORK AND CAB FOR ENGINEERING MACHINES

(71) Applicant: JIANGSU XCMG CONSTRUCTION MACHINERY RESEARCH INSTITUTE LTD., Xuzhou, Jiangsu (CN)

(72) Inventors: Younian FANG, Xuzhou, Jiangsu (CN); Lanzhong YANG, Xuzhou, Jiangsu (CN); Liwei XIAO, Xuzhou, Jiangsu (CN)

(73) Assignee: JIANGSU XCMG CONSTRUCTION MACHINERY RESEARCH INSTITUTE LTD., Xuzhou, Jiangsu (CN)

(21) Appl. No.: 18/247,641

(22) PCT Filed: Jul. 29, 2022
(86) PCT No.: PCT/CN2022/108853

§ 371 Date: Apr. 2, 2023

(30) Foreign Application Priority Data
Jun. 29, 2022 (CN) 202210748312.5

(51) Int. Cl. G06F 30/20; G06F 30/15; G06F 119/14

(52) U.S. Cl. CPC G06F 30/20; G06F 30/15; G06F 2119/14

(57) ABSTRACT

Disclosed are an optimal design method for top cross beams of an ROPS framework and a cab for engineering machines. The optimal design method comprises: analyzing bending stress of a portal hyperstatic structural mechanics model to obtain the ratio n of an inertia moment I of top cross beams to an inertia moment I of pillars when the maximum bending stress of the top cross beams is equal to the maximum bending stress of the pillars, such that lightweight design of the ROPS framework is realized.

### FIELD

The invention belongs to the technical field of cabs for engineering machines, and relates to an optimal design method for top cross beams of an ROPS framework and a cab for engineering machines.

### BACKGROUND

Engineering machines work in severe environments and travel along complicated and changeable paths, so rollover accidents happen frequently. Due to the large mass of engineering machines, the possibility of devastating injuries caused in the event of a rollover accident is extremely high, and the primary cause of these devastating injuries is extreme deformation of the cab caused by the accident. Rollover accidents are inevitable, and in order to reduce the loss of life and property caused by the accidents, the most effective and simplest method is to take passive protection, that is, to add a rollover protective structure (ROPS) on vehicles to provide safety protection.

An ROPS framework has become a standard configuration of the cab of engineering machines which work in severe environments. According to test requirements, the ROPS framework should meet the loading requirements of lateral, vertical and longitudinal loads and lateral load energy. During lateral loading. the cab is elastic-plastically deformed. plastic hinges appear at positions, where the bending moment is maximum or the structure is weak, of the framework to realize large lateral deformation displacement of the framework. which is beneficial for the absorption of lateral impact loads. The key to realizing lightweight and high-quality design of the ROPS framework is to reasonably plan the position and sequence of plastic hinges.

At present, top cross beams of the ROPS framework are either under-designed or over-designed according to experience. When the top cross beams are under-designed, plastic hinges will be generated on the top cross beams too early, so the top cross beams cannot effectively support pillars. When the top cross beams are over-designed. plastic hinges are generated on the pillars, which will increase the deformation of the pillars. Both cases are not beneficial to lightweight design of the ROPS framework.

### SUMMARY

Objective: to overcome the defects of the prior art, the invention provides an optimal design method for top cross beams of an ROPS framework and a cab for engineering machines.

The invention provides a method for designing an optimal ratio of the sectional inertia moment of top cross beams to the sectional inertia moment of pillars of an ROPS framework. By reasonably designing the top cross beams, the top cross beams and the root of the pillars can enter the plastic deformation zone at the same time to realize effective absorption of impact load energy.

The invention provides an optimal ROPS framework structure by analyzing the loading features of ROPS tests.

Technical solution: the technical solution adopted by the invention to solve the above technical problems is as follows:

In a first aspect, the invention provides an axially symmetric ROPS framework, which comprises pillars, cross beams and longitudinal beams;

Wherein, the pillars comprise A-pillars, B-pillars and D-pillars; the cross beams comprise top cross beams and bottom cross beams; the longitudinal beams comprise top longitudinal beams and bottom longitudinal beams;

The two A-pillars are connected through a first top cross beam and a first bottom cross beam to form a closed rectangular A-ring;

The two B-pillars are connected through a second top cross beam and a second bottom cross beam to form a closed rectangular B-ring;

The two D-pillars are connected through a third top cross beam and a third bottom cross beam to form a closed rectangular D-ring:

Four corners of the A-ring and corresponding four corners of the B-ring are connected through a first top longitudinal beam and a first bottom longitudinal beam, and four corners of the B-ring and four corresponding corners of the D-ring are connected through a second top longitudinal beam and a second bottom longitudinal beam, such that a closed spatial framework structure is formed.

In some embodiments, the ratio of an inertia moment I of the first top cross beam to an inertia moment I of the A-pillars I is n, and n ranges from 0.6 to 0.7.

In some embodiments, the ratio of an inertia moment I of the second top cross beam to an inertia moment I of the B-pillars is n, and n ranges from 0.6-0.7.

In some embodiments, the ratio of an inertia moment I of the third top cross beam to an inertia moment I of the D-pillars is n, and n ranges from 0.6-0.7.

In a second aspect, the invention provides an optimal design method for the top cross beams of the axially symmetric ROPS framework, which comprises:

S1, establishing a mechanics model: extracting a length dimension W of the top cross beams and a length dimension L of the pillars according to the ROPS framework structure to form a portal hyperstatic structural mechanics model, and obtaining, by analysis with the portal hyperstatic structural mechanics model, a bending moment distribution relation between the top cross beams and the pillars;

S2, selecting a design parameter: selecting a profile sectional inertia moment I, which is a key factor determining bending moment distribution in the mechanics model, as a design parameter of profiles;

S3, performing structural mechanics analysis: analyzing bending stress of the portal hyperstatic structural mechanics model by means of structural mechanics software to obtain the ratio n of the inertia moment I of the top cross beams to the inertia moment I of the pillars when the maximum bending stress of the top cross beams is equal to the maximum bending stress of the pillars; and

S4: establishing a relation: obtaining a relation for optimal design of the top cross beams according to the ratio n of the inertia moment I of the top cross beams to the inertia moment I of the pillars;

Selecting profiles of the top cross beams and the corresponding pillars according to the relation for optimal design of the top cross beams.

In some embodiments, the length dimension W of the top cross beams is 1.45 m-1.6 m, and the length dimension L of the pillars is 1.65 m-1.9 m.

In some embodiments, the bending moment distribution relation between the top cross beams and the pillars is: bending moment of the pillars Mₚᵢₗₗₐᵣ>bending moment of the top cross beam M_{top_cross beam}.

In some embodiments, the relation for optimal design of the top cross beam is: I_{top_cross beam}=nIₚᵢₗₗₐᵣ, and the ratio n of the inertia moment I of the top cross beams to the inertia moment I of the pillars ranges from 0.6 to 0.7.

In a third aspect, the invention further provides a cab for engineering machines, which comprises the axially symmetric ROPS framework.

Beneficial effects: according to the optimal design method for top cross beams of an ROPS framework and the cab for engineering machines, a structural mechanics model is analyzed to obtain an optimal ratio of the sectional inertia moment of the top cross beams to the sectional inertia moment of the pillars to realize lightweight and high-quality design of the ROPS framework. The method can greatly shorten the design time of the ROPS framework and improve the design quality of the ROPS framework. The invention has the following advantages:
(1) The invention provides a method for designing the optimal ratio of the sectional inertia moment of the top cross beams to the sectional inertia moment of the pillars of the ROPS framework;
(2) The invention provides a closed “ring” ROPS framework structure beneficial to force transfer:
(3) The design method provided by the invention can be implanted into an intelligent design software database.

### BRIEF DESCRIPTION OF THE DRAWINGS

FIG. 1 is a flow diagram of an optimal design method for top cross beams of an ROPS framework according to one embodiment;

FIG. 2 illustrates a closed “ring” structure of an ROPS framework according to one embodiment;

FIG. 3 is a schematic diagram of a portal hyperstatic structural mechanics model of an ROPS framework according to one embodiment.

### DETAILED DESCRIPTION

The technical solutions of the embodiments of the invention will be clearly and completely described below in conjunction with the accompanying drawings of these embodiments. Obviously, the embodiments in the following description are merely illustrative ones, and are not all possible ones of the invention. The following description of at least one illustrative embodiment is merely explanatory, and should not be construed as any limitation of the invention or the application or use of the invention. All other embodiments obtained by those ordinarily skilled in the art according to the following ones without creative labor should fall within the protection scope of the invention.

Unless otherwise expressly stated, the relative arrangement of components and steps, numeral expressions and numerical values expounded in the embodiments of the invention are not intend to limit the scope of the invention. Moreover, it should be understood that, for the sake of convenient description, the components in the drawings are not drawn according to actual dimension scale. Techniques, methods and devices known by those ordinarily skilled in related art may not be discussed in detail, and in proper cases. these techniques, method and devices should be construed as one part of the granted specification. In all examples illustrated and discussed here, any specific value should be interpreted as illustrative rather than restrictive. Thus, other examples of the illustrative embodiments may have different values. It should be noted that similar reference signs and alphabets represent similar items in the drawings below. Thus, once one item is defined in one drawing, it will not be further discussed in subsequent drawings.

In the description of the disclosure, it should be understood that terms such as “first” and “second” are used for defining parts merely for the purpose of distinguishing corresponding parts. Unless otherwise stated, these terms have no special meanings, and should not be construed as limitations of the protection scope of the disclosure.

In the description of the application, it should be understood that terms such as “central”. “longitudinal”, “cross”, “front”. “back”, “left”, “right”, “vertical”, “horizontal”, “top”. “bottom”, “inner” and “outer” are used to indicate directional or positional relations based on the accompanying drawings merely for the purpose of facilitating and simplifying the description, and do not indicate or imply that devices or elements referred to must be in a specific direction, or be configured and operated in a specific direction, so they should not be construed as limitations of the contents protected by the invention.

### DEFINITION OF TERMS

ROPS—a rollover protective structure, a series of structural members for reducing the possibility of injuries to a driver wearing a seat belt in the event of a roll-over;
ROPS framework—a spatial framework structure designed to meet ROPS design requirements:
Pillar—a part or component for vertical supporting;
Cross beam-a horizontally arranged beam;
Top cross beam-a cross beam at the top of the framework;
Sectional inertia moment I—the integral of a quadratic product of the area of micro-elements on a cross section and the distance from the micro-elements to a designated axis on the cross section; it is a geometric parameter for evaluating the sectional bending resistance of a component, and unless otherwise specifically stated, the axis of the sectional inertia moment passes through the centroid of the cross section;

Plastic hinge-a point appearing on a local part of a component of the ROPS framework subject to a bending moment, of which the opposite side yields but is not destroyed, and around which the component rotates within a limited angle;

Plastic deformation zone-a state where the ROPS framework can no longer maintain a static structure in presence of multiple plastic hinges during lateral loading;

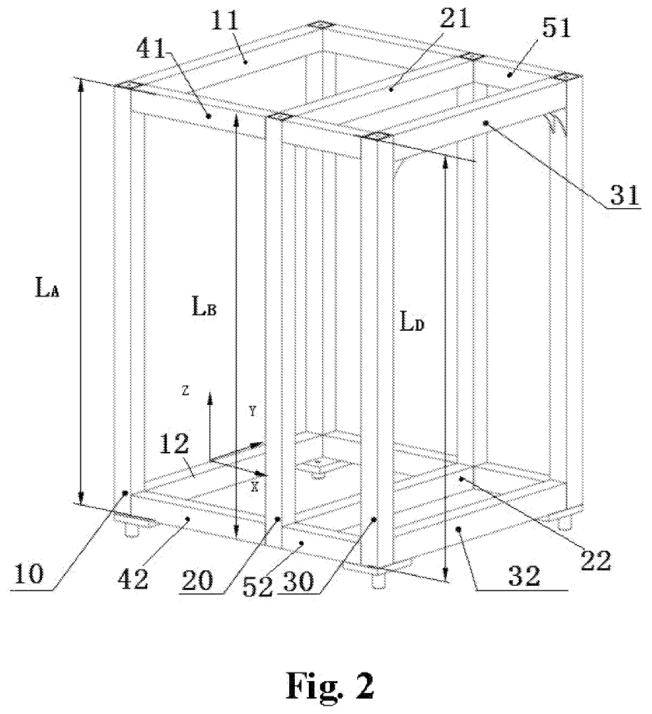

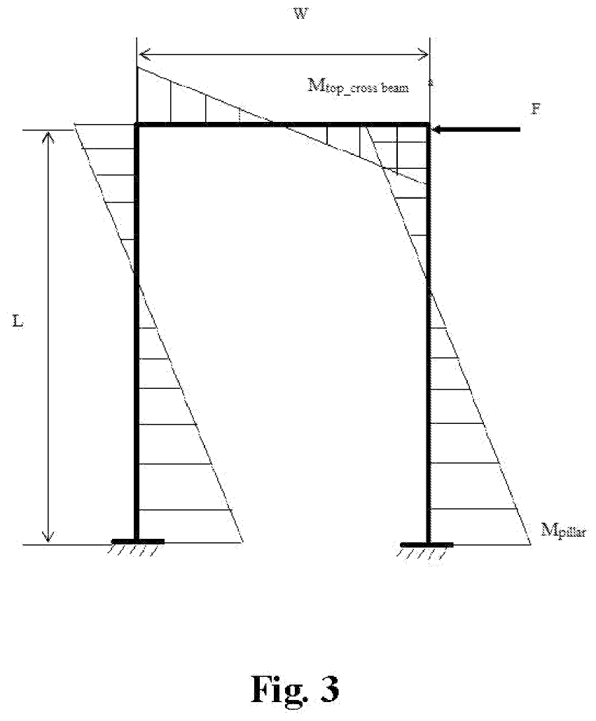

On the basis that the strictest ROPS test requirement is the lateral loading test, to facilitate lateral load transfer, a design method provided by the invention constructs a closed “ring” framework structure shown in FIG. 2 and a portal hyperstatic structural mechanics model shown in FIG. 3 to analyze a design objective that top cross beams and pillar enter the plastic deformation zone at the same time, so as to obtain a relation between anti-bending geometric parameters of the top cross beams and the pillars, and profiles of an ROPS framework are selected according to this relation.

### Embodiment 1

An axially symmetric and closed “ring” framework structure comprises pillars, a top cross beam and a bottom cross beam; one end of the top cross beam is connected to a top end of one of two pillars, and the other end of the top cross beam is connected to a top end of the other one of the two pillars; one end of the bottom cross beam is connected to a bottom end of one of two pillars, and the other end of the bottom cross beam is connected to a bottom end of the other one of the two pillars, such that the closed “ring” framework structure is formed.

An axially symmetric cab ROPS framework comprises multiple closed “ring” framework structures, and the multiple closed “ring” framework structures are connected in sequence through longitudinal beams.

In some embodiments, corner brackets are disposed at joints of the pillars and the top cross beams, and a limiting device is disposed at the bottom of the cab ROPS framework.

In some embodiments, as shown in FIG. 2, an axially symmetric cab ROPS framework comprises pillars, cross beams and longitudinal beams;

Wherein, the pillars comprise A-pillars 10, B-pillars 20, and D-pillars 30; the cross beams comprise top cross beams and bottom cross beams: the longitudinal beams comprise top longitudinal beams and bottom longitudinal beams;

The two A-pillars 10 are connected through a first top cross beam 11 and a first bottom cross beam 12 to form a closed rectangular A-ring;

The two B-pillars 20 are connected through a second top cross beam 21 and a second bottom cross beam 22 to form a closed rectangular B-ring;

The two D-pillars 30 are connected through a third top cross beam 31 and a third bottom cross beam 32 to form a closed rectangular D-ring;

Four corners of the A-ring and corresponding four corners of the B-ring are connected through a first top longitudinal beam 41 and a first bottom longitudinal beam 42, and four corners of the B-ring and corresponding four corners of the D-ring are connected through a second top longitudinal beam 51 and a second bottom longitudinal beam 52, such as a closed spatial framework structure is formed.

The A-ring, the B-ring and the D-ring are rectangular structures, and the whole ROPS framework is an axially symmetric structure.

Wherein, the longitudinal beams comprise top longitudinal beams and bottom longitudinal beams; to guarantee the flatness of the bottom of the whole ROPS framework, the bottom longitudinal beams and the bottom cross beams are basically located on a same plane (for example, the bottom longitudinal beams and the bottom cross beams are arranged horizontally); however, the length of the A-pillars, the length of the B-pillars and the length of the D-pillars are not definitely identical, so the top longitudinal beams and the top cross beams are not definitely located on a same plane.

In some embodiments, the ratio of the inertia moment I of the first top cross beam to the inertia moment I of the A-pillars is n, and n ranges from 0.6 to 0.7.

In some embodiments, the ratio of the inertia moment I of the second top cross beam to the inertia moment I of the B-pillars is n, and n ranges from 0.6 to 0.7.

In some embodiments, the ratio of the inertia moment I of the third top cross beam to the inertia moment I of the D-pillars is n, and n ranges from 0.6 to 0.7.

The ROPS framework is designed through a design method in Embodiment 2.

### Embodiment 2

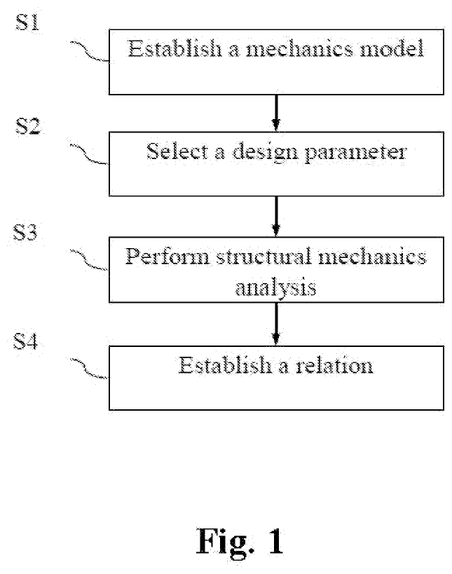

As shown in FIG. 1, an optimal design method for top cross beams of an axially symmetric ROPS framework comprises:

S1, establishing a mechanics model: extracting a length dimension W of the top cross beams and a length dimension L of the pillars according to the ROPS framework structure shown in FIG. 2, simplifying the pillars and the cross beams to form a portal hyperstatic structural mechanics model shown in FIG. 3, and obtaining, by analysis with the portal hyperstatic structural mechanics model, a bending moment distribution relation between the top cross beams and the pillars: bending moment of the pillars Mₚᵢₗₗₐᵣ>bending moment of the top cross beams M_{top_cross beam}; obtaining a “strong pillar and weak beam” design principle;

S2, selecting a design parameter: selecting the profile sectional inertia moment I, which is a key factor determining the bending moment distribution in the mechanics model, as a design parameter of profiles;

S3, performing structural mechanics analysis: analyzing the bending stress of the portal hyperstatic structural mechanics model by means of structural mechanics analysis software (such as a structural mechanics solver) to obtain the ratio n of the inertia moment I of the top cross beams to the inertia moment I of the pillars when the maximum bending stress of the top cross beams is equal to the maximum bending stress of the pillars, wherein n ranges from 0.6 to 0.7; and

S4, establishing a relation: obtaining a relation for optimal design of the top cross beams I_{top_cross beam}=nIₚᵢₗₗₐᵣ according to the ratio n of the inertia moment I of the top cross beams to the inertia moment I of the pillars:

selecting profiles of the top cross beams and the corresponding pillars according to the relation for optimal design of the top cross beams.

Wherein, the relation for optimal design of the top cross beams I_{top_cross beam}=(0,6-0.7) Iₚᵢₗₗₐᵣ is related to the outline dimension of the ROPS framework, is an inherent attribute of the ROPS framework, and is used for guiding the optimal design of the top cross beams of the ROPS framework. Outline dimensions of common machines can be summarized according to the design method of the invention to establish a relation database for optimal design of all cab ROPS frameworks.

### Embodiment 3

A cab for engineering machines comprises the ROPS framework in Embodiment 1, which is designed through the optimal design method for top cross beams of the ROPS framework in Embodiment 2.

The engineering machines may be hydraulic excavators, loaders, road rollers, land levelers and the like, and have all the advantages of the ROPS framework provided by the embodiments of the disclosure.

The above embodiments are merely preferred ones of the invention. It should be pointed out that those skilled in the art can make various improvements and embellishments without departing from the principle of the invention, and all these improvements and embellishments should also fall within the protection scope of the invention.

1. An axially symmetric ROPS framework, comprising pillars, cross beams and longitudinal beams;
wherein, the pillars comprise A-pillars, B-pillars and D-pillars; the cross beams comprise top cross beams and bottom cross beams; the longitudinal beams comprise top longitudinal beams and bottom longitudinal beams;
two said A-pillars are connected through a first top cross beam and a first bottom cross beam to form a closed rectangular A-ring;
two said B-pillars are connected through a second top cross beam and a second bottom cross beam to form a closed rectangular B-ring;
two said D-pillars are connected through a third top cross beam and a third bottom cross beam to form a closed rectangular D-ring;
four corners of the A-ring and corresponding four corners of the B-ring are connected through a first top longitudinal beam and a first bottom longitudinal beam, and four corners of the B-ring and four corresponding corners of the D-ring are connected through a second top longitudinal beam and a second bottom longitudinal beam, such that a closed spatial framework structure is formed.

2. The axially symmetric ROPS framework according to claim 1, wherein a ratio of an inertia moment I of the first top cross beam to an inertia moment I of the A-pillars I is n, and n ranges from 0.6 to 0.7.

3. The axially symmetric ROPS framework according to claim 1, wherein a ratio of an inertia moment I of the second top cross beam to an inertia moment I of the B-pillars is n, and n ranges from 0.6-0.7.

4. The axially symmetric ROPS framework according to claim 1, wherein a ratio of an inertia moment I of the third top cross beam to an inertia moment I of the D-pillars is n, and n ranges from 0.6-0.7.

5. An optimal design method for the top cross beams of the axially symmetric ROPS framework according to claim 1, comprising the followings steps:
extracting a length dimension W of the top cross beams and a length dimension L of the pillars according to the ROPS framework structure to form a portal hyperstatic structural mechanics model, and obtaining, by analysis with the portal hyperstatic structural mechanics model, a bending moment distribution relation between the top cross beams and the pillars;
selecting a profile sectional inertia moment I, which is a key factor determining bending moment distribution in the mechanics model, as a design parameter of profiles;
analyzing bending stress of the portal hyperstatic structural mechanics model by means of structural mechanics software to obtain the ratio n of the inertia moment I of the top cross beams to the inertia moment I of the pillars when the maximum bending stress of the top cross beams is equal to the maximum bending stress of the pillars; and
obtaining a relation for optimal design of the top cross beams according to the ratio n of the inertia moment I of the top cross beams to the inertia moment I of the pillars;
selecting profiles of the top cross beams and the corresponding pillars according to the relation for optimal design of the top cross beams.

6. The optimal design method for the top cross beams of the ROPS framework according to claim 5, wherein the length dimension W of the top cross beams is 1.45 m-1.6 m, and the length dimension L of the pillars is 1.65 m-1.9 m.

7. The optimal design method for the top cross beams of the ROPS framework according to claim 5, wherein the bending moment distribution relation between the top cross beams and the pillars is: bending moment of the pillars Mₚᵢₗₗₐᵣ>bending moment of the top cross beam M_{top_cross beam}.

8. The optimal design method for the top cross beams of the ROPS framework according to claim 5, wherein the relation for optimal design of the top cross beam is:
$${I}_{top\_cross beam} = {nI}_{pillar} .$$

9. The optimal design method for the top cross beams of the ROPS framework according to claim 5, wherein the ratio n of the inertia moment I of the top cross beams to the inertia moment I of the pillars ranges from 0.6 to 0.7.

10. A cab for engineering machines, comprising the axially symmetric ROPS framework according to claim 1.

11. The optimal design method for the top cross beams of the ROPS framework according to claim 8, wherein the ratio n of the inertia moment I of the top cross beams to the inertia moment I of the pillars ranges from 0.6 to 0.7.
